(19) United States
(12) Patent Application Publication
(10) Pub. No.: US 2010/0055367 A1
(43) Pub. Date: Mar. 4, 2010

(54) Multilayer Tube for Medical Use

(75) Inventor: Atsushi Ohigawa, Fukuroi (JP)

Correspondence Address: TYCO HEALTHCARE - EDWARD S. JARMOLOWICZ, 15 HAMPSHIRE STREET, MANSFIELD, MA, 02048, US

(73) Assignee: Tyco Healthcare Group LP, Mansfield, MA (US)

(21) Appl. No.: 12/511,208

(22) Filed: Jul. 29, 2009

(30) Foreign Application Priority Data
Aug. 29, 2008 (JP) 2008-220954

(51) Int. Cl. B32B 1/08

(52) U.S. Cl. 428/36.91; 264/171.26

(57) ABSTRACT

A multi-layer tube for medical purposes formed by simultaneous extrusion moulding at least a moulding material mixture comprising styrene/ethylene/butylene/styrene block copolymer, polypropylene, polyurethane and mineral oil, and a moulding material comprising polyurethane.

### TECHNICAL FIELD OF THE DISCLOSURE

The present invention concerns multi-layer tubes for medical purposes which can be used when supplying liquids such as drug solutions, blood and the like to a patient's body or when discharging drainage from a patient's body.

### BACKGROUND OF THE DISCLOSURE

Polyurethane resins and silicone resins are generally used as materials for moulding tubes for medical purposes. Tubes for medical purposes comprising polyurethane resin are characterized by having excellent insertion properties and being difficult to break, and tubes for medical purposes comprising silicone resin are characterized by their flexibility, and either type may be selected according to the circumstances. However, since neither type of tube is excellent in all respects, a multi-layer tube for medical purposes where the respective weaknesses are overcome by forming a plurality of layers with a plurality of materials which provide different properties is being used.

This tube for medical purposes (a catheter) is constructed with two layers, an outer layer comprising thermoplastic polymer which has been orientated in the direction of the long axis and an inner layer comprising thermoplastic polymer which has not been orientated. Thus materials such as polyurethane, polyester, nylon, fluorine-based elastomers and the like can be used for the thermoplastic polymer which forms the outer layer, and all of the abovementioned materials which form the outer layer and styrene-based elastomers such as SEBS, poly(vinyl acetate), hydrogenated styrene/butadiene rubber and the like can be used as the thermoplastic polymer which forms the inner layer. Furthermore, in cases where the compatibility of the material which forms the outer layer and the material which forms the inner layer is poor an adhesive intermediate layer is established between the outer layer and the inner layer to achieve binding of the inner layer and the outer layer.

However, with the abovementioned tubes for medical purposes the material from which the outer layer is constructed has a higher melting point than the material from which the inner layer is constructed and the thermoplastic polymer which forms the outer layer is drawn and set in an orientated state by means of a heat treatment at a temperature between the melting points after co-extrusion moulding and drawing. Consequently it is necessary to select two materials which have suitably different melting points and there is a problem in that it is difficult to realize a combination of suitable materials and there is a further problem in that production is complicated. Furthermore, the moulding of multi-layer tubes for medical purposes which have more than two layers is even more difficult. Moreover, there is a further problem in those cases where an adhesive intermediate layer is established between the layers where materials which have poor compatibility have been selected in that production is even more complicated.

The present disclosure is based upon an understanding of the situation outlined above and the aim of the disclosure is to provide multi-layer tubes for medical purposes where a plurality of layers can be moulded easily using materials which provide the preferred characteristics for each layer from which the multi-layer tube for medical purposes is constructed.

### SUMMARY OF THE DISCLOSURE

A multi-layer tube for medical purposes is provided comprising at least two or more layers formed by simultaneous extrusion molding. At least one of the at least two or more layers is formed by extrusion molding a mixture comprising a styrene/ethylene/butylene/styrene block copolymer, polypropylene, polyurethane and mineral oil. Another of the at least two or more layers is at least one layer formed by extrusion molding polyurethane. The at least two materials, are simultaneously extrusion molded to form a multi-layer tube comprising a layer of each of the at least two materials.

### BRIEF DESCRIPTION OF THE DRAWINGS

FIG. 1 is a cross sectional drawing which shows a multi-layer tube for medical purposes which is a first embodiment of the invention.

FIG. 2 is a partial cross sectional structural drawing which shows the essential outline of an extrusion moulding machine.

FIG. 3 is a cross sectional drawing which shows a multi-layer tube for medical purposes which is another embodiment of the invention.

Corresponding reference numerals indicate corresponding parts throughout the drawings, and herein the following reference numerals apply:
10, 30: Multi-layer tube for medical purposes
11, 31: Inner layer
12, 33: Outer layer
32: Intermediate layer

### DETAILED DESCRIPTION OF THE DISCLOSURE

A multi-layer tube for medical purposes which has been constructed in this way is furnished with a layer comprising a moulding material in which styrene/ethylene/butylene/styrene block copolymer, polypropylene, polyurethane and mineral oil are mixed. This mixture is referred to hereinafter as SEBS blend material. At least another layer comprises polyurethane. Thus the SEBS blend material provides flexibility and has good moulding properties and the polyurethane provides characteristics of excellent body compatibility, such as body-temperature softening characteristics, and is difficult to break.

Furthermore, SEBS blend material and polyurethane have good compatibility at the temperature where extrusion moulding is possible, for example at about 200° C. Hence, in those cases where a multi-layer tube for medical purposes is moulded with SEBS blend material and polyurethane there is no need for an adhesive intermediate layer and moulding is easy since it is completed with just the simultaneous extrusion moulding of the two moulding materials. Furthermore, it is possible to obtain a multi-layer tube for medical purposes which is suitable for the intended use by arranging the layer comprising SEBS blend material and the layer comprising polyurethane as the outer layer or inner layer in accordance with their characteristics.

Furthermore, in one embodiment of a multi-layer tube for medical purposes, the outer layer is moulded with moulding material comprising polyurethane and a layer comprising a moulding material mixture of styrene/ethylene/butylene/styrene block copolymer, polypropylene, polyurethane and mineral oil, is moulded on the inner peripheral side of the outer layer. When this is done it is possible to obtain a multi-layer tube for medical purposes which is furnished with an outer layer which has excellent compatibility with the body and which is difficult to break.

Furthermore, in another embodiment of a multi-layer tube for medical purposes of this disclosure, a layer comprising polyethylene or polypropylene is formed on the inner peripheral side of the layer comprising the moulding material mixture of styrene/ethylene/butylene/styrene block copolymer, polypropylene, polyurethane and mineral oil. The polyethylene or polypropylene and the SEBS blend material have good compatibility at the temperatures at which extrusion moulding is possible and so a multi-layer tube for medical purposes comprising three layers can be moulded easily. Furthermore, the polyethylene or polypropylene is resistant to chemicals and so it is ideal as the material from which the inner layer of a multi-layer tube for medical purposes is formed when a drug solution or the like is to be passed through the inside.

Furthermore, in still another embodiment of a multi-layer tube for medical purposes of this disclosure, the moulding material mixture of styrene/ethylene/butylene/styrene block copolymer, polypropylene, polyurethane and mineral oil comprises from 20 to 40% by weight of styrene/ethylene/butylene/styrene block copolymer, from 30 to 45% by weight of mineral oil and from 15 to 50% by weight in total of polypropylene and polyurethane. When this is so it is possible to mould a layer comprising SEBS blend material which provides even more desirable characteristics. In particular, it is possible to obtain a multi-layer tube for medical purposes which has excellent flexibility by setting the proportion by weight of mineral oil to from 30 to 45%.

Furthermore, in yet another embodiment of a multi-layer tube for medical purposes of this disclosure the proportions by weight of polypropylene and polyurethane included in the moulding material mixture comprising styrene/ethylene/ butylene/styrene block copolymer, polypropylene, polyurethane and mineral oil are both at least 1%. The proportions of polypropylene and polyurethane in this case are modified appropriately depending on where the layer comprising SEBS blend material is arranged. It is possible by this means to provide characteristics corresponding to the layer where the layer comprising SEBS blend material is arranged.

Furthermore, in yet another embodiment of a multi-layer tube for medical purposes of this disclosure the mineral oil is a paraffin-based oil, a naphthene-based oil or a higher fatty acid. When this is so the excellent effect of the mineral oil as a softening agent can be realized.

### Optimum Mode of Embodiment of the Invention

### DETAILED DESCRIPTION OF THE DRAWINGS

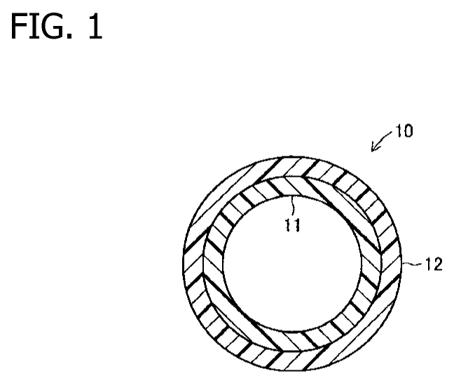

Embodiments of the disclosure are described below with reference to the drawings. FIG. 1 shows a cross sectional drawing of a multi-layer tube 10 for medical purposes which is an embodiment of the disclosure. This multi-layer tube 10 for medical purposes is constructed with an inner layer 11 comprising SEBS blend material (moulding material mixture comprising styrene/ethylene/butylene/styrene block copolymer, polypropylene, polyurethane and mineral oil) and an outer layer 12 comprising polyurethane resin which has been formed around the outer periphery of the inner layer 11. A blend of from 20 to 40% by weight of styrene/ethylene/butylene/styrene block copolymer, from 30 to 45% by weight of mineral oil and from 15 to 50% by weight in total of polypropylene and polyurethane is used for the SEBS blend material from which the inner layer 11 is formed, and the amount of polypropylene and the amount of polyurethane is set to at least 1% by weight in each case.

The inner layer 11 of the multi-layer tube for medical purposes in this case is formed from a mixture comprising 30% by weight of styrene/ethylene/butylene/styrene block copolymer, 38% by weight of mineral oil and 16% by weight each of polypropylene and polyurethane. Furthermore, a paraffin-based oil is used for the mineral oil of the SEBS blend material. The multi-layer tube 10 for medical purposes is formed as a tube of external diameter from 2 mm to 5 mm and internal diameter from 0.5 mm to 3 mm, and the thickness of the inner layer 11 is set to from 0.5 mm to 1 mm and the thickness of the outer layer 12 is set to from 1 mm to 4 mm. Furthermore, a material of Shore hardness from 30 A to 70 A can be used for the SEBS blend material which forms the inner layer 11 and a resin of Shore hardness from 70 A to 70 D can be used for the polyurethane resin which forms the outer layer 12. That is to say, the outer layer 12 is formed from a material slightly harder than the inner layer 11.

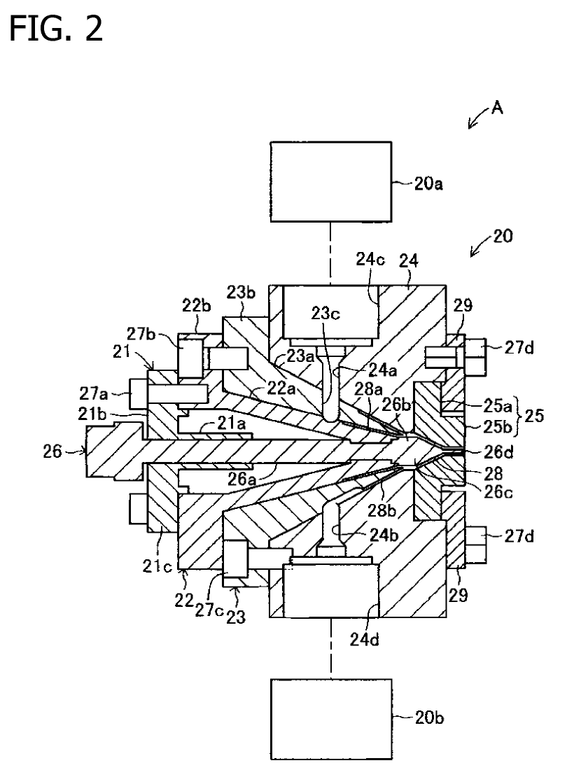

The multi-layer tube 10 for medical purposes which is formed in this way can be obtained by moulding SEBS blend material and soft thermoplastic resin material comprising polyurethane using the extrusion moulding machine A which is shown in FIG. 2. The extrusion moulding machine A is furnished with a mould 20 and a pair of extruding machines 20a and 20b. The mould 20 is furnished with a rear pin-holder 21 which is located at the back (the left-hand side in FIG. 2), a circular cone-like front pin holder 22 which is located in the middle, a circular cone-like bushing 23 which is located on the outer peripheral side of the front pin holder 22 and a block-like bushing holder 24 which is arranged between the outer peripheral side of the bushing 23 and the front (the right-hand side in FIG. 2). The front pin holder 22 and the bushing 23 are formed with a rear part of large diameter and a front part of small diameter.

Furthermore, a concavity is formed in the middle of the front of the bushing holder 24 and a ring-like bushing 25 is arranged in this concavity. A pin 26 is established inside the rear pin holder 21, the front pin holder 22, the bushing 23, the bushing holder 24 and the bushing 25. The rear pin holder 21 is constructed with a flange-like fixing plate 21b which protrudes to the outside established on the rear end outer perimeter of a cylindrical pin-holding part 21a. The pin 26 is established in the pin-holding part 21a and the rear part of the pin 26 is supported in the pin-holding part 21a.

The front pin holder 22 is constructed with a flange-like fixing plate 22b which protrudes to the outer peripheral side established on the rear end outer perimeter of the circular cone-like pin-holding part 22a. The front pin holder 22 is established in front of the rear pin holder 21 by overlapping the fixing plate part 22b on the front surface of the fixing plate 21b and fixing with a bolt 27a. The pin-holding part 22a extends front and back with a roughly constant thickness but the front end part is formed with gradual thinning on proceeding forward. That is to say, the front end inner peripheral surface of the pin-holding part 22a extends front to back with a roughly constant diameter and the front part of the pin 26 is supported by this front end inner peripheral surface.

The bushing 23 is constructed with a flange-like fixing plate 23b which protrudes to the outer peripheral side established on the rear end outer perimeter of a circular cone-like material channel forming part 23a. The bushing 23 is established at the outer perimeter of the material channel forming part 23a by overlapping the fixing plate part 23b on the front surface of the fixing plate 22b and fixing with a bolt 27b. The material channel forming part 23a has a thick rear part and becomes thinner gradually on proceeding forward from the rear part. Furthermore, in one part of the material channel forming part 23a (the upper part in FIG. 2) a material channel 23c which connects to the material channel 24a which is formed in the bushing holder 24 is formed penetrating from the outer peripheral surface to the inner peripheral surface, and the front end of this material channel 23c reaches the outer peripheral surface of the pin-holding part 22a.

A circular cone-like material channel 28a is formed between the outer peripheral surface of the front side part of the pin-holding part 22a and the inner peripheral surface of the front side part of the material channel forming part 23a, and the front end of the material channel 23c is connected to the material channel 28a. Furthermore, the front end of a material channel 24b which is formed in the bushing holder 24 reaches the outer peripheral surface of the other side (the bottom side in FIG. 2) of the material channel forming part 23a. A circular cone-like concavity corresponding to the outer peripheral surface of the material channel forming part 23a is formed in the middle of the rear surface of the bushing holder 24, and the bushing 23 has the material channel forming part 23a inserted into the circular cone-like concavity and is fixed to the bushing holder 24 by overlapping a fixing plate 23b on the rear surface of the bushing holder 24 and fixing with a bolt 27c.

A material entry port 24c which accepts the material which is being supplied from the extruding machine 20a is formed in one side of the bushing holder 24 and a material entry port 24d which accepts the material which is being supplied from the extruding machine 20b is formed in the other side of the bushing holder 24. The material entry port 24c is connected to the material channel 24a and the material entry port 24d is connected to the material channel 24b. A circular cone-like material channel 28b is formed between the outer peripheral surface of the front part of the material channel forming part 23a and the inner peripheral surface of the front part of the bushing holder 24, and the front end of the material channel 24b is connected to the material channel 28b.

Thus, the material which is supplied from the extruding machine 20a through the material entry port 24c, the material channel 24a, the material channel 23c and the material channel 28a is used to mould the inner layer 11 and the material which is supplied from the extruding machine 20b through the material entry port 24d, the material channel 24b and the material channel 28b is used to mould the outer layer 12. Furthermore, a circular concavity is formed in the middle of the front surface of the bushing holder 24 and the bushing 25 is established in this concavity. The bushing 25 is constructed with a large-diameter ring-like fixing part 25a which is arranged in the concavity of the bushing holder 24 and a small-diameter ring-like protruding part 25b part which protrudes to the front from the middle of the front surface of the fixing part 25a.

Thus, the bushing 25 is fixed in a state where the fixing part 25a is held between the bushing holder 24 and the fixing plate 29 by overlapping the ring-like fixing plate 29 on the outer peripheral side of the front surface of the fixing part 25a and the front surface of the bushing holder 24 and fixing the fixing plate 29 to the bushing holder 24 with the bolt 27d. Furthermore, a hole passing front-to-back is formed in the middle of the bushing 25 and a combined-flow material channel 28 in which the flows of the material channel 28a and the material channel 28b are combined is formed between the inner peripheral surface of this hole and the outer peripheral surface of the front end part of the pin 26. That is to say, the material which has been supplied from the material channel 28a flows on the inner peripheral side of the combined-flow material channel 28 and the material which has been supplied from the material channel 28b flows on the outer peripheral side of the combined-flow material channel 28.

The material channel 28a and the material channel 28b form a combined-flow somewhat to the rear of the rear surface of the bushing 25 and the part of the combined-flow material channel 28 to the rear of the rear surface of the bushing 25 is formed with a cylindrical form of roughly the same diameter in the front to back direction. Furthermore, the part of the combined-flow material channel 28 which is located inside the fixing part 25a is formed with a circular conical shape where the diameter gradually becomes smaller from the back (upstream side) to the front (downstream side), and the part of the combined-flow material channel 28 which is located inside the protruding part 25b is formed with a cylindrical shape of roughly the same small diameter.

The pin 26 is constructed with a fixing part 26a, a straight part 26b, a tapered part 26c and a small diameter part 26d which are arranged in this order from the back end to the front end. The part to be fixed 26a is fixed in the pin holding part 21a of the rear pin holder 21 and the front end part of the pin holding part 22a of the front pin holder 22. The part facing the front end internal perimeter of the pin holding part 22a has a smaller diameter than the other part, and part of the pin holding part 22a is engaged with this part. The straight part 26b is formed with a cylindrical form which is short in the axial direction and extends from the front end of the part to be fixed 26a towards the front, and the tapered part 26c is formed with a circular conical form which extends from the front end of the straight part 26b towards the front, gradually becoming narrower towards the front end.

Furthermore, the small diameter part 26d is formed in the form of a rod of small diameter which extends from the front end of the tapered part 26c towards the front and its front end surface is located at the same location in the front-to-back direction as the front surface of the bushing 25. The material channel 28a and the material channel 28b form a combined-flow on the outer peripheral rear end part of the straight part 26b and the combined-flow material channel 28 is formed between the outer peripheral surfaces of the straight part 26b, tapered part 26c and small diameter part 26c and the inner peripheral surfaces of the bushing holder 24 and bushing 25.

When moulding a multi-layer tube 10 for medical purposes using the extrusion moulding machine A which has been constructed in this way, first of all moulding material comprising SEBS blend material is introduced into the extruding machine 20a and moulding material comprising polyurethane resin is introduced into the extruding machine 20b. Then, after heating the mould 20 to a suitable temperature (around 200° C.), the moulding materials which have been introduced into the extruding machines 20a and 20b are discharged by means of the screws while being heated to about 200° C. in the heated cylinders of the extruding machines 20a and 20b respectively and packed into the material entry ports 24c and 24d.

Moreover, the moulding materials are discharged from the extruding machines 20a and 20b respectively and the moulding material comprising SEBS blend material is transferred into the combined-flow material channel 28 via the material channel 24a and the material channel 28a, and the moulding material comprising polyurethane resin is transferred into the combined-flow material channel 28 via the material channel 24b and the material channel 28b. The moulding material comprising SEBS blend material which has been introduced into the combined-flow material channel 28 is formed into the form of a cylinder of roughly constant diameter as it is passing along the inner peripheral side in the combined flow material channel 28 and the diameter gradually becomes smaller as it is transferred to the downstream end of the combined-flow material channel 28.

The moulding material comprising polyurethane resin is formed into the form of a cylinder of roughly constant diameter as it is passing along the outer peripheral side inside the combined-flow material channel 28 and the diameter gradually becomes smaller as it is transferred to the downstream end of the combined flow material channel 28. At this time the two moulding materials are in contact and formed into a tube of small diameter comprising two layers, and this is extruded to the outside at the downstream end of the combined-flow material channel 28. The tube which has been extruded to the outside can be used as a multi-layer tube 10 for medical purposes after cooling and shrinking to substantially similar shapes by some 40 to 70%. During the extrusion moulding the two moulding materials are heated to a suitable temperature and gradually transformed until they are moved from the material channels 28a and 28b into the combined-flow material channel 28 and so they are moulded without being forced.

In the way described above, the multi-layer tube 10 for medical purposes of this embodiment is constructed with two layers, namely an inner layer 11 comprising SEBS blend material and an outer layer 12 comprising polyurethane resin. Consequently, the multi-layer tube 10 for medical purposes is provided with flexibility by the inner layer 11 and with excellent compatibility with the body in terms of body-temperature softening properties and the like and made difficult to break by the outer layer 12. Furthermore, the SEBS blend material and the polyurethane are compatible at the temperature where extrusion moulding is possible and so unified moulding can be achieved easily.

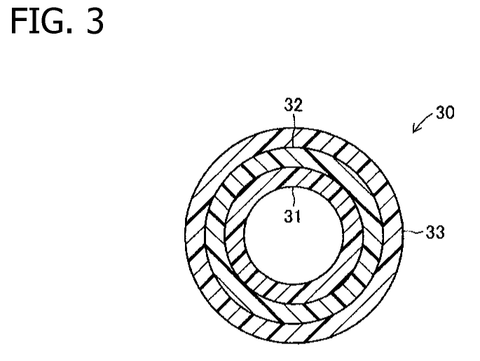

FIG. 3 shows a multi-layer tube 30 for medical purposes which is another embodiment of the disclosure. The multi-layer tube 30 for medical purposes is constructed with an inner layer 31 comprising polyethylene resin or polypropylene resin, an intermediate layer 32 comprising SEBS blend material which is formed on the outer periphery of the inner layer 31 and an outer layer 33 comprising polyurethane resin which is formed on the outer periphery of the intermediate layer 32. The same SEBS blend material as that used to form the inner layer 11 of the multi-layer tube 30 for medical purposes described earlier was used for the SEBS blend material with which the intermediate layer 32 was formed. The thickness of the inner layer 31 is set to from 0.1 mm to 1 mm, and materials which have a Shore hardness of from 70 A to 70 D are used for the polyethylene resin or polypropylene resin from which the inner layer 31 is constructed. The construction of the other parts of this multi-layer tube 30 for medical purposes was the same as for the multi-layer tube 10 for medical purposes described earlier.

In an extruding machine for moulding the multi-layer tube 30 for medical purposes another bushing is established between the front part pin holder 22 and the bushing 23 in the extruding machine A described earlier and a material channel for the flow of moulding material comprising polyethylene resin or polypropylene resin for forming the inner layer 31 is established between the inner peripheral surface of the bushing and the outer peripheral surface of the front pin holder 22. Furthermore, an additional extruding machine is also provided for supplying moulding material comprising polyethylene resin or polypropylene resin to the mould. During the moulding the multi-layer tube 30 for medical purposes can be moulded easily since there is good compatibility between the polyethylene resin or polypropylene resin and the SEBS blend material at a temperature of 200° C. where extrusion moulding is possible. Furthermore, polyethylene resin or polypropylene resin is resistant to drug products and so it is ideal as the material for constructing the inner layer 31 of a multi-layer tube 30 for medical purposes.

Moreover, the present invention is not limited to the embodiments described above and it can be modified appropriately. For example, in the embodiment described earlier the inner layer 11 of the multi-layer tube 10 for medical purposes and the intermediate layer 32 of the multi-layer tube 30 for medical purposes were made with 30% by weight of styrene/ethylene/butylene/styrene block copolymer, 38% by weight of mineral oil and 16% by weight of each of polypropylene and polyurethane, but the proportions by weight can be suitably modified within the ranges of from 20 to 40% by weight of styrene/ethylene/butylene/styrene block copolymer, from 30 to 45% by weight of mineral oil and from 15 to 50% by weight in total of polypropylene and polyurethane.

Furthermore, paraffin-based oil was used for the mineral oil in the embodiments described above, but naphthene-based oils and higher fatty acids can also be used for the mineral oil. Moreover, the material used to form each layer of the multi-layer tube for medical purposes can be modified appropriately. Moreover, the multi-layer tubes for medical purposes of this invention can also be used as tubes for digestive tract purposes, trans-intestinal feeding tubes, tubes for intestinal pressure reducing purposes, tubes for drainage purposes and the like.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A multi-layer tube for medical purposes, comprising at least two, or more, layers formed by simultaneous extrusion molding, wherein at least one of the at least two, or more, layers is formed by extrusion molding a mixture comprising a styrene/ethylene/butylene/styrene block copolymer, polypropylene, polyurethane, and mineral oil, and at least one of the at least two, or more, layers is formed by extrusion molding polyurethane.

2. The multi-layer tube according to claim 1 wherein the polyurethane layer is an outer layer, and the layer comprising the styrene/ethylene/butylene/styrene block copolymer, polypropylene, polyurethane and mineral oil mixture is molded on the inner peripheral side of the outer layer.

3. The multi-layer tube according to claim 2 wherein a layer comprising an extrusion molded polyethylene or polypropylene is molded on the inner peripheral side of the layer comprising styrene/ethylene/butylene/styrene block copolymer, polypropylene, polyurethane, and mineral oil mixture.

4. The multi-layer tube according to claim 1 wherein the mixture comprises from 20 to 40% by weight of styrene/ethylene/butylene/styrene block copolymer, from 30 to 45% by weight of mineral oil, and from 15 to 50% by weight in total of polypropylene and polyurethane.

5. The multi-layer tube according to claim 2 wherein the mixture comprises from 20 to 40% by weight of styrene/ethylene/butylene/styrene block copolymer, from 30 to 45% by weight of mineral oil, and from 15 to 50% by weight in total of polypropylene and polyurethane.

6. The multi-layer tube according to claim 3 wherein the mixture comprises from 20 to 40% by weight of styrene/ethylene/butylene/styrene block copolymer, from 30 to 45% by weight of mineral oil, and from 15 to 50% by weight in total of polypropylene and polyurethane.

7. The multi-layer tube according to claim 4 wherein the mixture comprises from 20 to 40% by weight of styrene/ethylene/butylene/styrene block copolymer, from 30 to 45% by weight of mineral oil, and from 15 to 50% by weight in total of polypropylene and polyurethane, and wherein the polypropylene and polyurethane are each present in an amount of at least 1% by weight.

8. The multi-layer tube according to claim 5 wherein the mixture comprises from 20 to 40% by weight of styrene/ethylene/butylene/styrene block copolymer, from 30 to 45% by weight of mineral oil, and from 15 to 50% by weight in total of polypropylene and polyurethane, and wherein the polypropylene and polyurethane are each present in an amount of at least 1% by weight.

9. The multi-layer tube according to claim 6, wherein the mixture comprises from 20 to 40% by weight of styrene/ethylene/butylene/styrene block copolymer, from 30 to 45% by weight of mineral oil, and from 15 to 50% by weight in total of polypropylene and polyurethane, and wherein the polypropylene and polyurethane are each present in an amount of at least 1% by weight.

10. The multi-layer tube according to claim 1 wherein the mineral oil is a paraffin-based oil, a naphthene-based oil, or a higher fatty acid.

11. The multi-layer tube according to claim 2 wherein the mineral oil is a paraffin-based oil, a naphthene-based oil, or a higher fatty acid.

12. The multi-layer tube according to claim 3 wherein the mineral oil is a paraffin-based oil, a naphthene-based oil, or a higher fatty acid.

13. The multi-layer tube according to claim 4 wherein the mineral oil is a paraffin-based oil, a naphthene-based oil, or a higher fatty acid.

14. The multi-layer tube according to claim 5 wherein the mineral oil is a paraffin-based oil, a naphthene-based oil, or a higher fatty acid.

15. The multi-layer tube according to claim 6 wherein the mineral oil is a paraffin-based oil, a naphthene-based oil, or a higher fatty acid.

16. The multi-layer tube according to claim 7 wherein the mineral oil is a paraffin-based oil, a naphthene-based oil, or a higher fatty acid.

17. The multi-layer tube according to claim 8 wherein the mineral oil is a paraffin-based oil, a naphthene-based oil, or a higher fatty acid.

18. The multi-layer tube according to claim 9 wherein the mineral oil is a paraffin-based oil, a naphthene-based oil, or a higher fatty acid.
